(19) United States
(12) Patent Application Publication
(10) Pub. No.: US 2024/0002746 A1
(43) Pub. Date: Jan. 4, 2024

(54) CITRUS OIL EXTRACT

(71) Applicant: Firmenich SA, Satigny (CH)

(72) Inventors: Elizabeth BERDIS, Plainsboro, NJ (US); John ARRUDA, Plainsboro, NJ (US); Long CHEN, Shanghai (CN); Hui-Juan ZHANG, Shanghai (CN)

(21) Appl. No.: 18/253,036

(22) PCT Filed: Nov. 12, 2021
(86) PCT No.: PCT/EP2021/081553

§ 371 Date: May 15, 2023

(30) Foreign Application Priority Data
Nov. 16, 2020 (WO) PCT/CN2020/129016
Dec. 21, 2020 (EP) 20216229.3

(51) Int. Cl. C11B 9/02; C11B 9/00; A23L 27/12

(52) U.S. Cl. CPC C11B 9/022; C11B 9/0061; C11B 9/0034; C11B 9/0076; C11B 9/0049; A23L 27/13

(57) ABSTRACT

The present invention relates to a citrus oil extract comprising a reduced amount of oxidative byproduct compounds, wherein the amount of oxidative byproduct compounds is less than 2500 ppm. Preferably oxidative byproduct compound is selected from the group consisting of: p-cymene, t-p-menth-2-en-1-ol, t-p-mentha-2,8-dienol, t-limonene oxide, camphor, p-cymen-8-ol, t-limonene 8,9-epoxide, c-limonene 8,9-epoxide and t-carveol. The invention also relates to methods for the preparation of an citrus oil extract, and a flavored or perfumed consumer product comprising the citrus oil extract of the invention.

### TECHNICAL FIELD

The present invention relates to an a citrus oil extract comprising a reduced amount of oxidative byproduct compounds, wherein the amount of oxidative byproduct compounds is less than 2500 ppm as well as flavoring compositions comprising such an extract and a method for the preparation of such an extract. The invention further concerns the use of such an extract as a taste or flavor ingredient in a consumer product and a method of enhancing, improving, modifying the taste or flavor of a consumer product by making use of such an extract.

### BACKGROUND

Citrus oil extracts are widely used in the food, beverage, perfumery and pharmaceutical industries. They are popular due to the attractive taste and aromas they provide to the consumer, and are a major component when taking consumer acceptance as a criteria for product development. In recent years consumers have become more conscious of the quality and production method used to prepare citrus oil extracts. Natural products which are prepared without any synthetic chemical steps have become more popular due to perceived preservation of the nutritional value of the fruit, including the flavour, colour, taste, pigments, etc.

An important criterion when preparing citrus oil extracts is to minimize the quantity of oxidative byproducts generated during the extraction process. This is because such products are undesirable from a consumer perspective since they impart undesirable notes to the extract.

Traditional methods of producing citrus oil extracts uses apparatuses in which the oil is heated for a long period of time (usually in excess of 10 hours) at a temperature of over 100° C. Under such conditions compounds such as terpenes (which are readily present in all citrus oils dehydrogenation, epoxidation, double bond cleavages, allylic oxidation and/or rearrangements in the presence of heat, to form oxidative byproducts. As stated above the presence of such products in citrus oil extracts is undesirable from a consumer perspective.

Hence the present inventors sought to prepare citrus oil extracts comprising reduced amount of oxidative byproduct compounds using alternative extraction methods to those presently used while still being natural or also called “clean label” extracts.

### DESCRIPTION OF THE FIGURES

FIG. 1: Oxidative byproduct compounds composition of a citrus oil extract of the invention from lime.

### DETAILED DESCRIPTION

A first aspect of the invention provides a citrus oil extract comprising a reduced amount of oxidative byproduct compounds, wherein the amount of oxidative byproduct compounds is less than 2500 ppm.

Citrus oils are well known flavoring and perfuming compositions. Citrus oils are prepared from a citrus fruit using well known extraction methods in the art. In a typical process the endocarp of the fruit is subjected to mechanical rupturing to break down the tissue and release the oils. The oils are subsequently washed from the tissue resulting in a citrus oil/water mixture. The oils are then isolated from the mixture to provide the citrus oil.

However, such citrus oils are problematic when used in preparing food and perfumery products, since the important note-imparting compounds are too dilute and the high level of terpenes causes solubility problems and therefore can be difficult to use in industrial context. Hence extracts are prepared from citrus oils which concentrate the note-imparting compounds while reducing the amount of terpenes.

Traditional methods of producing citrus oil extracts uses apparatuses in which the oil is heated for a long period of time (usually in excess of 10 hours) at a temperature of over 100° C. Under such conditions compounds such as terpenes (which are readily present in all citrus oils) undergo dehydrogenation, epoxidation, double bond cleavages, allylic oxidation and/or rearrangements in the presence of heat, to from oxidative byproducts. Specific compounds which are generated during citrus oil extraction process due to excessive time at high temperature conditions are well known in the art and the term is well understood by the skilled person. Oxidation of citrus compounds has been shown to be influenced by temperature. The formation of off-flavours, limonene oxides, p-cymene, carveol, from the oxidation of terpenes, such as d-Limonene, has been shown in the prior art.

However when present in citrus oil extracts such oxidative byproduct compounds impart undesirable notes. For example, p-Cymene can give rancid and oxidized citrus notes, limonene oxides can give a minty spearmint herbal, camphor can give a medicinal, camphoreous, mentholic and woody notes, t-p-menth-2-en-1-ol can give a herbal note, t-p-mentha-2,8-dienol can give a minty note and p-cymen-8-ol can give spicy, celery, herbal, black pepper notes.

As provided below, the inventors have devised a new innovative process which significantly reduces the quantity of oxidative byproduct compounds in the citrus oil extract. This results in a citrus oil extract which is bright, fresh and authentic compared to the less body, flat and distilled character of citrus oil extract prepared using existing extraction protocols (see the accompanying examples for details on this assessment). The reason for this improvement in the consumer performance is due to the reduction in the amount of oxidative byproduct compounds, specifically to less than 2500 ppm.

WO2001/039610 discloses to the treatment of citrus oils with cysteine or a salt or ester thereof. In contrast the presently claimed invention does not use such an additive. Moreover the extraction process disclosed in this document is significantly different that used to prepare the citrus oil extract of the present invention; for example the extraction process used in this document does not involve any distillation. Hence the process described in this document would not produce a citrus oil extract as claimed herein.

U.S. Pat. No. 5,558,893 relates to the removal of pesticides from citrus peel oil, which is very different than the problem addressed by the present invention. Moreover, the extraction process disclosed in this document is also significantly different to that used to prepare the citrus oil extract of the present invention; for example the extraction process used in this document uses thin film distillation,

WO2016121186 relates to a process for producing a purified citrus refined oil. The process use thin film distillation to remove volatiles from non-volatiles and the subsequent use of vacuum distillation to remove monoterpenes with maintaining oxygenates. Subjecting citrus oils to increased heating time during vacuum distillation would contribute to more oxidative compounds. In contrast the presently claimed citrus oil extract is prepared using an improved method using hybrid thin-film technology which allows fractionation within the thin film. As a result of this, the process described in this document would not prepare a citrus oil extract as claimed herein.

KR101921193 relates to a process for producing citrus oil from peel using a combination of cold press and thin film evaporated method, with addition of sugar to the cold pressed oil emulsion. This process is significantly different than the hybrid thin-film distillation process used in the present invention, and hence the process described in this document would not prepare a citrus oil extract as claimed herein.

WO2008138083 relates to a process for the clarification and enrichment of oils from citrus fruits using molecular distillation methods. However, the document only discloses processes using thin film distillation which would not prepare a citrus oil extract as claimed herein

The present invention concerns a citrus oil extract. It is prepared from the citrus oils described above. The citrus oil extract of the invention therefore has less terpenes than citrus oils extracted from the fruit, preferably less than 50% of the total composition, more preferably less than 5%

The citrus oil extract of the invention may be obtained from the oil from any citrus fruit from the family Rutaceae. This family is also known as the rue family and contains flowering plants that generally have a strong scent. Citrus fruits include, but not limited to lemon, lime, orange, grapefruit, satsuma and tangerine, mandarin, yuzu, bergamot and pomelo. Preferably the citrus oil extract is not orange. More preferably the citrus oil extract is lemon or lime.

The citrus oil extract of the invention comprising a reduced amount of oxidative byproduct compounds. Preferably the amount of oxidative byproduct compounds is less than 2500 ppm, more preferably less than 2300 ppm, more preferably less than 2100 pmm, more preferably less than 1900 ppm, more preferably less than 1800 ppm, more preferably less than 1700 ppm, preferably less than 1600 ppm, preferably less than 1500 ppm, preferably less than 1400 ppm

By “oxidative byproduct compounds” we include compounds which are generated during citrus oil extraction process due to excessive time at high temperature conditions. As stated above such compounds are undesirable from a consumer perspective since they impart undesirable notes to the extract.

In a preferred embodiment the oxidative byproduct compound is selected from the group consisting of: p-cymene, t-p-menth-2-en-1-ol, t-p-mentha-2,8-dienol, t-limonene oxide, camphor, p-cymen-8-ol, t-limonene 8,9-epoxide, c-limonene 8,9-epoxide and t-carveol.

The structure and CAS numbers for the compounds are very well known in the art and the skilled person would understand what each of the oxidative byproduct compounds are.

Preferably the citrus oil extract is lemon or lime. In a preferred embodiment the citrus fruit is lemon and the amount of oxidative byproduct compounds is less than 1500 ppm, preferably 1400 ppm, more preferably less than 1320 ppm, more preferably 1311 ppm. Preferably the amount of oxidative byproduct compounds is 1385 ppm. In a further preferred embodiment the citrus fruit is lime and the amount of oxidative byproduct compounds is less than 1900 ppm, preferably 1800 ppm, more preferably less than 1700 ppm, more preferably less than 1650 ppm, more preferably 1649. Preferably the amount of oxidative byproduct compounds is 1453 ppm

In a preferred embodiment of the invention is wherein the oxidative byproduct compound is: (i) p-cymene and the amount is 230 ppm or less, (ii) t-p-menth-2-en-1-ol and the amount is 110 ppm or less, (iii) t-p-mentha-2,8-dienol and the amount is 125 ppm or less, (iv) t-limonene oxide and the amount is 10 ppm or less, (v) camphor and the amount is 185 ppm or less, (vi) p-cymen-8-ol and the amount is 220 ppm or less, (vii) t-limonene 8,9-epoxide and the amount is 290 ppm or less, (viii) c-limonene 8,9-epoxide and the amount is 350 ppm or less, and/or (ix) t-carveol and the amount is 420 ppm or less.

In an alternative preferred embodiment of the invention the citrus oil extract is lemon and the extract comprises (i) p-cymene and the amount is 100 ppm or less, (ii) t-p-menth-2-en-1-ol and the amount is 5 ppm or less, (iii) t-p-mentha-2,8-dienol and the amount is 75 ppm or less, (iv) t-limonene oxide and the amount is 5 ppm or less, (v) camphor and the amount is 180 ppm or less, (vi) p-cymen-8-ol and the amount is 120 ppm or less, (vii) t-limonene 8,9-epoxide and the amount is 290 ppm or less, (viii) c-limonene 8,9-epoxide and the amount is 150 ppm or less, and/or (ix) t-carveol and the amount is 420 ppm or less.

Preferably the citrus oil extract is lemon and the extract comprises (i) p-cymene and the amount is 100 ppm, (ii) t-p-menth-2-en-1-ol and the amount is 0 ppm, (iii) t-p-mentha-2,8-dienol and the amount is 75 ppm, (iv) t-limonene oxide and the amount is 0 ppm (v) camphor and the amount is 178 ppm, (vi) p-cymen-8-ol and the amount is 116 ppm, (vii) t-limonene 8,9-epoxide and the amount is 282 ppm, (viii) c-limonene 8,9-epoxide and the amount is 147 ppm and (ix) t-carveol and the amount is 413 ppm.

In an alternative preferred embodiment of the invention the citrus oil extract is lime and extract comprises (i) p-cymene and the amount is 230 ppm or less, (ii) t-p-menth-2-en-1-ol and the amount is 110 ppm or less, (iii) t-p-mentha-2,8-dienol and the amount is 125 ppm or less, (iv) t-limonene oxide and the amount is 5 ppm or less, (v) camphor and the amount is 150 ppm or less, (vi) p-cymen-8-ol and the amount is 200 ppm or less, (vii) t-limonene 8,9-epoxide and the amount is 220 ppm or less, (viii) c-limonene 8,9-epoxide and the amount is 350 ppm or less, and/or (ix) t-carveol and the amount is 300 ppm or less.

Preferably the citrus oil extract is lime and the extract comprises (i) p-cymene and the amount is 229 ppm, (ii) t-p-menth-2-en-1-ol and the amount is 0 ppm, (iii) t-p-mentha-2,8-dienol and the amount is 123 ppm, (iv) t-limonene oxide and the amount is 0 ppm (v) camphor and the amount is 145 ppm, (vi) p-cymen-8-ol and the amount is 195 ppm, (vii) t-limo106ene 8,9-epoxide and the amount is 214 ppm, (viii) c-limonene 8,9-epoxide and the amount is 345 ppm and (ix) t-carveol and the amount is 292 ppm.

A further aspect of the invention provides an orange citrus oil extract comprising a reduced amount of oxidative byproduct compounds, wherein the amount of oxidative byproduct compounds is less than 15000 ppm

Preferably the orange citrus oil extract comprises (i) p-cymene and the amount is 100 ppm or less, (ii) t-p-menth-2-en-1-ol and the amount is 100 ppm or less, (iii) t-p-mentha-2,8-dienol and the amount is 1500 ppm or less, (iv) t-limonene oxide and the amount is 2500 ppm or less, (v) camphor and the amount is 100 ppm or less, (vi) p-cymen-8-ol and the amount is 500 ppm or less, (vii) t-limonene 8,9-epoxide and the amount is 100 ppm or less, (viii) c-limonene 8,9-epoxide and the amount is 1000 ppm or less, and/or (ix) t-carveol and the amount is 8000 ppm or less.

Preferably the orange citrus oil comprises: t-p-mentha-2,8-dienol and the amount is 1269 ppm, t-limonene oxide and the amount is 2183 ppm, p-cymen-8-ol and the amount is 388 ppm, c-limonene 8,9-epoxide and the amount is 900 ppm and t-carveol and the amount is 7712 ppm.

When used herein, the “ppm” value indicated the quantity of the designated compound in the citrus oil extract. Methods of determining the ppm value of a compound in a sample are well known in the art, for example using gas chromatography. An example of the use of such a measurement system is provided herein in the examples below.

Another object of the present invention is the use of the citrus oil extract of the invention as flavoring or perfuming composition. In other words, it concerns a method or a process to confer, enhance, improve or modify the odor properties of a flavoring or perfuming composition or of a flavored or perfumed article or of a surface, which method comprises adding to said composition or article an effective amount of the citrus oil extract of the invention, e.g. to impart its typical note.

By “use of the citrus oil extract of the invention” it has to be understood here also the use of any composition containing the citrus oil extract of the invention and which can be advantageously employed in the perfumery or flavor industry.

Furthermore, the citrus oil extract of the invention can be advantageously used in all the fields of flavor to positively impart or modify the taste of a consumer product into which said composition is added. Consequently, the present invention relates to a flavored consumer product comprising the citrus oil extract of the invention as defined above.

For the sake of clarity, by “flavored consumer product” it is meant to designate an edible product or oral composition such as, for example, pharmaceutical compositions, edible gel mixes and compositions, dental compositions, foodstuffs beverages and beverage products. The flavored consumer product may be in a different form. A non-exhaustive list of suitable form of the consumer product may include fried, frozen, marinated, battered, chilled, dehydrated, powder blended, canned, reconstituted, retorted, baked, cooked, fermented, microfiltred, pasteurized, blended or preserved. Therefore, a flavored consumer product according to the invention comprises the invention's composition, as well as optional benefit agents, corresponding to taste and flavor profile of the desired edible product, e.g. a cream dessert.

Hence a further aspect of the invention provides flavored consumer product comprising the citrus oil extract of the invention wherein the product is selected from the group consisting of: baked goods, dairy based products, dairy analogues, products based on fat and oil or emulsions thereof, milk products, confectionary products, desserts, chocolate and compound coatings, cereal products, non-alcoholic beverages including flavored carbonated and still mineral and table waters, alcoholic beverages or instant or ready-to-drink beverages.

The nature and type of the constituents of the foodstuffs or beverages do not warrant a more detailed description here, the skilled person being able to select them on the basis of his general knowledge and according to the nature of said product.

Typical examples of said flavored consumer product include:
Baked goods (e.g. breads, dry biscuits, cakes, rice cakes, rice crackers, cookies, crackers, donuts, muffins, pastries, pre-mixes, other baked goods),
Non-alcoholic beverages (e.g. aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, broth drinks),
Alcoholic beverages (e.g. beer and malt beverages, spirituous beverages, wines, liquors),
Instant or ready-to-drink beverages (e.g. instant vegetable drinks, powdered soft drinks, instant coffees and teas, black teas, green teas, oolong teas, herbal infusions, cacaos (e.g. water-based), tea-based drinks, coffee-based drinks, cacao-based drinks, infusions, syrups, frozen fruits, frozen fruit juices, water-based ices, fruit ices, sorbets),
Cereal products (e.g. breakfast cereals, cereal bars, energy bars/nutritional bars, granolas, pre-cooked ready-made rice products, rice flour products, millet and sorghum products, raw or pre-cooked noodles and pasta products),
Dairy based products (e.g. fruit or flavored yoghurts, ice creams, fruit ices, frozen desserts, fresh cheeses, soft cheeses, hard cheeses, milk drinks, wheys, butters, partially or wholly hydrolysed milk protein-containing products, fermented milk products, condensed milks and analogues)
Dairy analogues (imitation dairy products) containing non-dairy ingredients (plant-based proteins, vegetable fats),
Confectionary products (e.g. filings, toppings, chewing gums, hard and soft candies),
Chocolate and compound coatings (e.g. chocolates, spreads),
Products based on fat and oil or emulsions thereof (e.g. mayonnaises, spreads, regular or low fat margarines, butter/margarine blends, flavored oils, shortenings, remoulades, dressings, salad dressings, spice preparations, peanut butters),
Eggs or egg products (dried eggs, egg whites, egg yolks, custards),
Desserts (e.g. gelatins, puddings, dessert creams),
Products made of soya protein or other soya bean fractions (e.g. soya milk and products made therefrom, soya lecithin-containing preparations, fermented products such as tofu or tempeh or products manufactured therefrom, soya sauces),
Vegetable preparations (e.g. ketchups, sauces, processed and reconstituted vegetables, dried vegetables, deep frozen vegetables, pre-cooked vegetables, vegetables pickled in vinegar, vegetable concentrates or pastes, cooked vegetables, potato preparations),
Fruit preparations (e.g. jams, marmalades, canned fruits)
Vegetarian meat analogues or meat replacers, vegetarian burgers
Spices or spice preparations (e.g. mustard preparations, horseradish preparations, pickles), spice mixtures and, in particular seasonings which are used, for example, in the field of snacks.
Snack articles (e.g. baked or fried potato crisps or potato dough products, bread dough products, extrudates based on maize, rice or ground nuts),
Ready dishes (e.g. instant noodles, rice, pastas, pizzas, tortillas, wraps) and soups and broths (e.g. stock, savory cubes, dried soups, instant soups, pre-cooked soups, retorted soups), sauces (instant sauces, dried sauces, ready-made sauces, gravies, sweet sauces, a relish sauces, a sour sauces),
oral care product, such as toothpastes, mouth washes, dental care products (e.g. denture adhesives), dental rinsing, mouth sprays, dental powders, dental gels or dental floss,
pet or animal food.

Preferably, the flavored consumer product may be baked goods, dairy based products, dairy analogues, products based on fat and oil or emulsions thereof, milk products, confectionary products, desserts, chocolate and compound coatings, cereal products, non-alcoholic beverages, alcoholic beverages or instant or ready-to-drink beverages.

Preferably, the flavored consumer product may be covertures and filling, products based on sugars, breads, dry biscuits, cakes, rice cakes, rice crackers, cookies, crackers, donuts, muffins, pastries, pre-mixes, filings, toppings, fruit or flavored yoghurts, ice creams, fruit ices, frozen desserts, spreads, regular or low fat margarines, butter/margarine blends, flavored oils, shortenings, dressings, spice preparations, peanut butters, fresh cheeses, soft cheeses, milk drinks, wheys, butters, partially or wholly hydrolysed milk protein-containing products, fermented milk products, condensed milk and analogues, gelatins, puddings, dessert creams, chocolates, spreads, aqueous beverages, enhanced/slightly sweetened water drinks, flavored carbonated and still mineral and table waters, carbonated soft drinks, non-carbonated beverages, carbonated waters, still waters, softs, bottled waters, sports/energy drinks, juice drinks, vegetable juices, vegetable juice preparations, beer and malt beverages, spirituous beverages, wines, liquors, instant vegetable drinks, powdered soft drinks, instant coffees and teas, black teas, green teas, oolong teas, herbal infusions, cacaos, tea-based drinks, coffee-based drinks, cacao-based drinks, infusions, syrups, chewing gums, hard and soft candies, frozen fruits, frozen fruit juices, water-based ices, fruit ices, sorbets, breakfast cereals, cereal bars, energy bars/nutritional bars, granolas, pre-cooked ready-made rice products, rice flour products, millet and sorghum products, raw or pre-cooked noodles and pasta products.

Some of the above-mentioned flavored consumer products may represent an aggressive medium for the citrus oil extract of the invention, so that it may be necessary to protect the citrus oil extract of the invention from premature decomposition, for example by encapsulation.

The proportions in which the citrus oil extract of the invention can be incorporated into the various of the aforementioned products vary within a wide range of values. These values are dependent on the nature of the consumer product to be flavored and on the desired organoleptic effect as well as the nature of the co-ingredients in a given base when the citrus oil extract of the invention are mixed with perfuming or flavoring ingredients, solvents or additives commonly used in the art.

Typical effective amounts are in the order of 0.001 ppm to 1000 ppm, more preferably 0.1 ppm to 500 ppm, more preferably 0.5 ppm to 350 ppm, most preferably 1 ppm to 250 ppm, most preferably 1 ppm to 150 ppm, most preferably 1 ppm to 100 ppm, most preferably 1 ppm to 50 ppm, most preferably 1 ppm to 30 ppm, most preferably 1 ppm to 20 ppm, most preferably 1 ppm to 10 ppm the invention's extract based on the weight of the composition or of the article into which it is incorporated.

The citrus oil extract of the invention can also be advantageously used in all the fields of modern perfumery, i.e. fine or functional perfumery, to positively impart or modify the odor of a consumer product into which said composition is added. Consequently, another object of the present invention consists of by a perfumed consumer product comprising, the citrus oil extract of the invention, as defined above.

For the sake of clarity, “perfumed consumer product” is meant to designate a consumer product which delivers at least a pleasant perfuming effect to the surface or space to which it is applied (e.g. skin, hair, textile, air, or home surface). In other words, a perfumed consumer product according to the invention is a perfumed consumer product which comprises a functional formulation, as well as optionally additional benefit agents, corresponding to the desired consumer product, and an olfactive effective amount of the citrus oil extract of the invention. For the sake of clarity, said perfumed consumer product is a non-edible product.

Hence a further aspect of the invention provides a perfumed article comprising the citrus oil extract of the invention wherein the perfumed article is selected from the group consisting of: an aromatic water, a perfume, a cologne, a bath gel, a shower gel, a shampoo, a hair care product, a cosmetic preparation, a deodorant, an air freshener, a detergent, a fabric softener, and a household cleaner.

The nature and type of the constituents of the perfumed consumer product do not warrant a more detailed description here, which in any case would not be exhaustive, the skilled person being able to select them on the basis of his general knowledge and according to the nature and the desired effect of said product.

Non-limiting examples of suitable perfumed consumer product include a perfume, such as a fine perfume, a splash or eau de parfum, a cologne or a shave or after-shave lotion; a fabric care product, such as a liquid or solid detergent, a fabric softener, a liquid or solid scent booster, a fabric refresher, an ironing water, a paper, a bleach, a carpet cleaner, a curtain-care product; a body-care product, such as a hair care product (e.g. a shampoo, a coloring preparation or a hair spray, a color-care product, a hair shaping product, a dental care product), a disinfectant, an intimate care product; a cosmetic preparation (e.g. a skin cream or lotion, a vanishing cream or a deodorant or antiperspirant (e.g. a spray or roll on), a hair remover, a tanning or sun or after sun product, a nail product, a skin cleansing, a makeup); or a skin-care product (e.g. a soap, a shower or bath mousse, oil or gel, or a hygiene product or a foot/hand care products); an air care product, such as an air freshener or a “ready to use” powdered air freshener which can be used in the home space (rooms, refrigerators, cupboards, shoes or car) and/or in a public space (halls, hotels, malls, etc. . . . ); or a home care product, such as a mold remover, a furnisher care product, a wipe, a dish detergent or a hard-surface (e.g. a floor, bath, sanitary or a window-cleaning) detergent; a leather care product; a car care product, such as a polish, a wax or a plastic cleaner.

Some of the above-mentioned perfumed consumer products may represent an aggressive medium for the invention's composition, so that it may be necessary to protect the latter from premature decomposition, for example by encapsulation or by chemically binding it to another chemical which is suitable to release the ingredient part of the invention's composition upon a suitable external stimulus, such as an enzyme, light, heat or a change of pH.

According to any one of the above embodiments, the citrus oil extract of the invention may be combined with one or more flavoring or perfuming co-ingredient.

By “flavoring or perfuming co-ingredient” it is meant here a compound, which is used in flavoring or perfuming preparations or compositions to impart a hedonic effect. In other words such an ingredient, to be considered as being a flavoring or perfuming one, must be recognized by a person skilled in the art as being able to impart or modify in a positive or pleasant way the taste or the odor of a composition, and not just as having a taste or an odor.

The nature and type of the flavoring or perfuming co-ingredients present in the composition do not warrant a more detailed description here, the skilled person being able to select them on the basis of its general knowledge and according to intended use or application and the desired organoleptic effect. In general terms, these flavoring or perfuming co-ingredients belong to chemical classes as varied as alcohols, aldehydes, ketones, esters, ethers, acetates, nitriles, terpenoids, nitrogenous or sulphurous heterocyclic compounds and essential oils, and said flavoring or perfuming co-ingredients can be of natural or synthetic origin. Many of these co-ingredients are in any case listed in reference texts such as the book by S. Arctander, Perfume and Flavor Chemicals, 1969, Montclair, New Jersey, USA, or its more recent versions, or in other works of a similar nature, as well as in the abundant patent literature in the field of flavor and perfumery. It is also understood that said co-ingredients may also be compounds known to release in a controlled manner various types of flavoring or perfuming compounds.

A non-limiting list of suitable flavoring co-ingredient which could be used includes phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 2,6-dimethoxy-phenol, 2-ethoxy-5-(1-propenyl)phenol, 4-ethenylphenol, 2-methyl-phenol, 4-hydroxy-benzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxy-benzoic acid, 1,3-benzodioxole-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, ethyl 3-phenyl-2-propenoate, methyl 3-phenyl-2-propenoate, ethyl benzoate, 1,4-dimethoxy-benzene, 2-ethyl-3-hydroxy-4H-pyran-4-one, 3-phenyl-2-propenal, phenylacetaldehyde, 5,6-dihydro-6-pentyl-2H-pyran-2-one, decanoic acid, butanoic acid; 2-methylpropanoic acid, dihydro-5-pentyl-2(3H)-furanone, methyl 2-hydroxybenzoate, methyl 2-hydroxybenzoate, 6-methyl-2H-1-benzopyran-2-one, 3,4-dihydro-2H-1-benzopyran-2-one, 1-benzopyran-2-one, hexahydro-3,6-dimethyl-2(3H)-benzofuranone, tetrahydro-6-propyl-2H-pyran-2-one, 6-butyltetrahydro-2H-pyran-2-one, 6-heptyltetrahydro-2H-pyran-2-one, 3-phenyl-2-propen-1-ol, 2-furanmethanol, 3-phenyl-2-propenoic acid, 2-furancarboxaldehyde, 3-hydroxy-2-butanone, 2,3-pentanedione, 2-hydroxybenzaldehyde, 5-pentylfuran-2(5H)-one, methyl 2-hydroxy-4-methoxybenzoate, 5-allyl-1,2,3-trimethoxybenzene, (−)-(1R,4E,9S)-4,11,11-trimethyl-8-methylenebicyclo[7.2.0]undec-4-ene, tetrahydro-6-pentyl-2H-pyran-2-one, 3-methylbutanal, 1-(2-hydroxy-4-methoxyphenyl)ethanone, cocoa extract, vanilla extract, benzoin extract, peru balsam extract, tolu extract, Guaiacwood oil and a combination thereof. Preferably, flavoring co-ingredient may be selected from the group consisting of phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 2,6-dimethoxy-phenol, 2-ethoxy-5-(1-propenyl)phenol, 4-ethenylphenol, 2-methyl-phenol, 4-hydroxy-benzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxy-benzoic acid, 1,3-benzodioxole-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, 3-phenyl-2-propenyl-ol, 2-furanmethanol, 3-phenyl-2-propenoic acid, 2-furancarboxaldehyde, 3-hydroxy-2-butanone, 2,3-pentanedione, Tetrahydro-6-pentyl-2H-pyran-2-one, 3-methyl-butanal, 1-(2-hydroxy-4-methoxyphenyl)ethanone, cocoa extract, vanilla extract, benzoin extract, peru balsam extract, tolu extract, Guaiacwood oil and a combination thereof. Even more preferably, the flavoring co-ingredient may be selected from the group consisting of phenol, 2-methoxyphenol, 2-methoxy-4-vinyl-phenol, 2-methoxy-4-(2-propen-1-yl)phenol, 2-methoxy-4-(1-propen-1-yl)phenol, 2-methoxy-4-(1-propen-1-yl)phenol, 2-methoxy-4-methyl-phenol, 2-ethoxy-5-(1-propenyl)phenol, 4-ethenylphenol, 4-methoxybenzaldehyde, benzaldehyde, 4-methoxy-benzoic acid; 1,3-benzodioxole-5-carbaldehyde, 3-hydroxy-2-methyl-4H-pyran-4-one, 4-hydroxy-2,5-dimethyl-3-furanone, 1-(2-hydroxy-4-methoxyphenyl)ethanone and a combination thereof.

The concentrations (in ppm RTC) of these compounds are: phenol (0.0001-0.3); 2-methoxyphenol (0.0001-0.5); 2-methoxy-4-vinyl-phenol (0.0001-0.3); 2-methoxy-4-(2-propen-1-yl)phenol; 2-methoxy-4-(1-propen-1-yl)phenol (0.0001-0.1); 2-methoxy-4-methyl-phenol (0.0001-0.5); 2-ethoxy-5-(1-propenyl)phenol (0.0001-5); 4-ethenylphenol (0.0001-0.3); 4-methoxy benzaldehyde (0.0005-5); benzaldehyde (0.0001-5); 4-methoxy-benzoic acid (0.1-200); 1,3-benzodioxole-5-carbaldehyde (0.01-50); 3-hydroxy-2-methyl-4H-pyran-4-one (0.05-200), 4-hydroxy-2,5-dimethyl-3-furanone (0.05-100).

According to any one of the above embodiment, the citrus oil extract of the invention may be combined with at least one flavor or perfumery carrier. The term “flavor or perfumery carrier” designates a material which is substantially neutral from a flavor or perfumery point of view, insofar as it does not significantly alter the organoleptic properties of flavoring ingredients or of perfumery ingredients. The carrier may be a liquid or a solid.

Suitable liquid carriers include, for instance, an emulsifying system, i.e. a solvent and a surfactant system, or a solvent commonly used in flavors or perfumery. A detailed description of the nature and type of solvents commonly used in flavor or perfumery cannot be exhaustive. Suitable solvents used in flavor include, for instance, propylene glycol, triacetine, caprylic/capric triglyceride (Neobee®), triethyl citrate, benzylic alcohol, ethanol, vegetable oils such as Linseed oil, sunflower oil or coconut oil, glycerol. One can cite as non-limiting examples of perfumery solvents, solvents such as butylene or propylene glycol, glycerol, dipropyleneglycol and its monoether, 1,2,3-propanetriyl triacetate, dimethyl glutarate, dimethyl adipate 1,3-diacetyloxypropan-2-yl acetate, diethyl phthalate, isopropyl myristate, benzyl benzoate, benzyl alcohol, 2-(2-ethoxyethoxy)-1-ethano, tri-ethyl citrate, ethanol, water/ethanol mixtures, limonene or other terpenes, isoparaffins such as those known under the trademark Isopar® (origin: Exxon Chemical) or glycol ethers and glycol ether esters such as those known under the trademark Dowanol® (origin: Dow Chemical Company), or hydrogenated castors oils such as those known under the trademark Cremophor® RH 40 (origin: BASF) or mixtures thereof.

Suitable solid carriers include, for instance, absorbing gums or polymers, or even encapsulating materials. Examples of such materials may comprise wall-forming and plasticizing materials, such as mono, di- or polysaccharides, natural or modified starches, hydrocolloids, cellulose derivatives, polyvinyl acetates, polyvinylalcohols, xanthan gum, arabic gum, acacia gum or yet the materials cited in reference texts such as H. Scherz, Hydrokolloid: Stabilisatoren, Dickungs-und Geliermittel in Lebensmitteln, Band 2 der Schriftenreihe Lebensmittelchemie, Lebensmittelqualitat, Behr's VerlagGmbH & Co., Hamburg, 1996. Encapsulation is a well-known process to a person skilled in the art, and may be performed, for instance, using techniques such as spray-drying, agglomeration, extrusion, coating, plating, coacervation and the like.

The citrus oil extract of the invention may comprise at least one flavor adjuvant. By “flavor adjuvant”, it is meant here an ingredient capable of imparting additional added benefit such as a color (e.g. caramel), chemical stability, and so on. A detailed description of the nature and type of adjuvant commonly used in flavoring compositions cannot be exhaustive. Nevertheless, such adjuvants are well known to a person skilled in the art who will be able to select them on the basis of its general knowledge and according to intended use or application. One may cite as specific non-limiting examples the following: viscosity agents (e.g. emulsifier, thickeners, gelling and/or rheology modifiers, e.g. pectin or agar gum), stabilizing agents (e.g. antioxidant, heat/light and or buffers agents e.g. citric acid), coloring agents (e.g. natural or synthetic or natural extract imparting color), preservatives (e.g. antibacterial or antimicrobial or antifungal agents, e.g. benzoic acid), vitamins and mixtures thereof.

The citrus oil extract of the invention may be combined with at least one perfumery adjuvant. By “perfumery adjuvant” we mean here an ingredient capable of imparting additional added benefit such as a color, a particular light resistance, chemical stability, etc. A detailed description of the nature and type of adjuvant commonly used in perfuming composition cannot be exhaustive, but it has to be mentioned that said ingredients are well known to a person skilled in the art. One may cite as specific non-limiting examples the following: viscosity agents (e.g. surfactants, thickeners, gelling and/or rheology modifiers), stabilizing agents (e.g. preservatives, antioxidant, heat/light and or buffers or chelating agents, such as BHT), coloring agents (e.g. dyes and/or pigments), preservatives (e.g. antibacterial or antimicrobial or antifungal or anti irritant agents), abrasives, skin cooling agents, fixatives, insect repellants, ointments, vitamins and mixtures thereof.

According to any one of the above embodiments, the citrus oil extract of the invention may be combined with sweeteners. Non limited-examples of suitable sweeteners includes common saccharide sweeteners, e.g., sucrose, fructose (e.g., D-fructose), glucose (e.g., D-glucose); sweetener compositions comprising natural sugars, such as stevia (all types and grades), corn syrup (including high fructose corn syrup) or other syrups or sweetener concentrates derived from natural fruit and vegetable sources; semisynthetic “sugar alcohol” sweeteners such as erythritol, isomalt, lactitol, mannitol, sorbitol, xylitol, maltodextrin, glycerol, threitol, arabitol, ribitol, and dulcitol; artificial sweeteners such as miraculin, aspartame, superaspartame, saccharin, saccharin-sodium salt, acesulfame-K, cyclamate, sodium cyclamate, and alitame; other sweeteners such as trehalose, melizitose, melibiose, raffinose, palatinose, lactulose, cyclamic acid, mogroside, tagatose (e.g., D-tagatose), maltose, galactose (e.g., D-galactose), L-rhamnose, D-sorbose, maunose (e.g., D-maunose), lactose, L-arabinose, D-ribose, D-glyceraldehyde, curculin, brazzein, mogroside, Neohesperidin dihydrochalcone (NHDC), neotame and other aspartame derivatives, D-tryptophan, D-leucine, D-threonine, glycine, D-asparagine, D-phenylalanine, L-proline, maltitol, hydrogenated glucose syrup (HGS), magap, sucralose, lugduname, sucrononate, sucrooctate, monatin, phyllodulcin, hydrogenated starch hydrolyzate (HSH), stevioside, rebaudioside A, rebaudioside D, rebadioside M, and other sweet Stevia based glycosides, lo han guo, thaumatin, monellin, carrelameand and other guanidine-based sweeteners.

According to any one of the above embodiments, the citrus oil extract of the invention may be combined with at least one cooling agent. Non limited-examples of suitable cooling agent includes WS-23 (2-Isopropyl-N,2,3-trimethylbutyramide), FEMA 3804; WS-3 (N-Ethyl-p-menthane-3-carboxamide), FEMA 3455; WS-5 [Ethyl 3-(p-menthane-3-carboxamido)acetate], FEMA 4309; WS-12 (1R,2S,5R)—N-(4-Methoxyphenyl)-p-menthanecarboxamide, FEMA 4681; WS-27 (N-Ethyl-2,2-diisopropylbutanamide), FEMA 4557; N-Cyclopropyl-5-methyl-2-isopropylcyclohexanecarboxamide, FEMA 4693, WS-116 (N-(1,1-Dimethyl-2-hydroxyethyl)-2,2-diethylbutanamide), N-(1,1-Dimethyl-2-hydroxyethyl)2,2-diethylbutanamide, FEMA 4603, Menthoxyethanol, FEMA 4154, N-(4-cyanomethylphenyl)-p-menthanecarboxamide, FEMA 4496; N-(2-(Pyridin-2-yl)ethyl)-3-p-menthanecaboxamide, FEMA 4549; N-(2-Hydroxyethyl)-2-isopropyl-2,3-dimethylbutanamide, FEMA 4602 and (also N-(4-(carbamoylmethyl)phenyl)-menthylcarboxamide, FEMA 4684; (1R,2S,5R)—N-(4-Methoxyphenyl)-p-menthanecarboxamide (WS-12), FEMA 4681; (2S,5R)—N-[4-(2-Amino-2-oxoethyl)phenyl]-p-menthanecarboxamide, FEMA 4684; and N-Cyclopropyl-5-methyl-2-isopropylcyclohexanecarbonecarboxamide, FEMA 4693; 2-[(2-p-Menthoxy)ethoxy]ethanol, FEMA 4718; (2,6-Diethyl-5-isopropyl-2-methyltetrahydropyran, FEMA 4680); trans-4-tert-Butylcyclohexanol, FEMA 4724; 2-(p-tolyloxy)-N-(1H-pyrazol-5-yl)-N-((thiophen-2-yl)methyl)acetamide, FEMA 4809; Menthone glycerol ketal, FEMA 3807; menthone glyceryl ketal (FEMA GRAS 3808); (−)-Menthoxypropane-1,2-diol; 3-(1-Menthoxy)-2-methylpropane-1,2-diol, FEMA 3849; Isopulegol; (+)-cis & (−)-trans p-Menthane-3,8-diol, Ratio˜62:38, FEMA 4053; 2,3-dihydroxy-p-menthane; 3,3,5-trimethylcyclohexanone glycerol ketal; menthyl pyrrolidone carboxylate; (1R,3R,4S)-3-menthyl-3,6-dioxaheptanoate; (1R,2S,5R)-3-menthyl methoxyacetate; (1R,2S,5R)-3-menthyl 3,6,9-trioxadecanoate; (1R,2S,5R)-3-menthyl 3.6,9-trioxadecanoate; (1R,2S,5R)-3-menthyl (2-hydroxyethoxy)acetate; (1R,2S,5R)-menthyl 11-hydroxy-3,6,9-trioxaundecanoate; Cubebol, FEMA 4497; N-(4-cyanomethylphenyl) p-menthanecarboxamide, FEMA 4496; 2-isopropyl-5-methylcyclohexyl 4-(dimethylamino)-4-oxobutanoate, FEMA 4230; N-(4-cyanomethylphenyl) p-menthanecarboxamide, FEMA 4496; N-(2-pyridin-2-ylethyl) p-; menthanecarboxamide, FEMA 4549, Menthyl lactate, FEMA 3748; 6-isopropyl-3,9-dimethyl-1,4-dioxaspiro[4.5]decan-2-one, FEMA 4285; N-benzo[1,3]dioxol-5-yl-3-p-menthanecarboxamide; N-(1-isopropyl-1,2-dimethylpropyl)-1,3-benzodioxole-5-carboxamide; N—(R)-2-oxotetrahydrofuran-3-yl-(1R,2S,5R)-p-menthane-3-carboxamide; mixture of 2,2,5,6,6-pentamethyl-2,3,6,6a-tetrahydropentalen-3a(1H)-ol and 5-(2-hydroxy-2-methylpropyl)-3,4,4-trimethylcyclopent-2-en-1-one; (1R,2S,5R)-2-isopropyl-5-methyl-N-(2-(pyridin-2-yl)ethyl)cyclohexanecarboxamide, FEMA 4549; (2S,5R)-2-isopropyl-5-methyl-N-(2-(pyridin-4-yl)ethyl)cyclohexanecarboxamide; N-(4-cyanomethylphenyl) p-menthanecarboxamide, FEMA 4496; (1S,2S,5R)—N-(4-(cyanomethyl)phenyl)-2-isopropyl-5-methylcyclohexanecarboxamide; 1/7-isopropyl-4/5-methyl-bicyclo[2.2.2]oct-5-ene derivatives; 4-methoxy-N-phenyl-N-[2-(pyridin-2-yl)ethyl]benzamide; 4-methoxy-N-phenyl-N-[2-(pyridin-2-yl)ethyl]benzenesulfonamide; 4-chloro-N-phenyl-N-[2-(pyridin-2-yl)ethyl]benzenesulfonamide; 4-cyano-N-phenyl-N-[2-(pyridin-2-yl)ethyl]benzenesulfonamid; 4-((benzhydrylamino)methyl)-2-methoxyphenol; 4-((bis(4-methoxyphenyl)-methylamino)-methyl)-2-methoxyphenol; 4-((1,2-diphenylethylamino)methyl)-2-methoxyphenol; 4-((benzhydryloxy)methyl)-2-methoxyphenol, 4-((9H-fluoren-9-ylamino)methyl)-2-methoxyphenol; 4-((benzhydrylamino)methyl)-2-ethoxyphenol; 1-(4-methoxyphenyl)-2-(1-methyl-1H-benzo[d]imidazol-2-yl)vinyl4-methoxybenzoate; 2-(1-isopropyl-6-methyl-1H-benzo[d]imidazol-2-yl)-1-(4-methoxyphenyl)vinyl4-methoxybenzoate; (Z)-2-(1-isoprop yl-5-methyl-1H-benzo[d]imidazol-2-yl)-1-(4-methoxy-phenyl)vinyl-4-methoxybenzoate; 3-alkyl-p-methan-3-ol derivatives; derivatives of fenchyl, D-bornyl, L-bornyl, exo-norbornyl, 2-methylisobornyl, 2-ethylfenchyl, 2-methylbornyl, cis-pinan-2-yl, verbanyl and isobornyl; menthyl oxamate derivatives; menthyl 3-oxocarboxylic acid esters; N alpha-(Menthanecarbonyl)amino acid amides; p-menthane carboxamide and WS-23 analogs; (−)-(1R,2R,4S)-dihydroumbellulol; p-menthane alkyloxy amides; cyclohexane derivatives; butone derivatives; a mixture of 3-menthoxy-1-propanol and 1-menthoxy-2-propanol; 1-[2-hydroxyphenyl]-4-[2-nitrophenyl-]-1,2,3,6-tetrahydropyrimidine-2-one; 4-methyl-3-(1-pyrrolidinyl)-2[5H]-furanone; and combinations thereof. Preferably, the cooling agent may be selected from the group consisting of menthol, menthol methyl ether, menthone glyceryl acetal (FEMA GRAS 3807), menthone glyceryl ketal (FEMA GRAS 3808), menthyl lactate (FEMA GRAS 3748), menthyl acetate, menthol ethylene glycol carbonate (FEMA GRAS 3805), menthol propylene glycol carbonate (FEMA GRAS 3806), menthyl-N-ethyloxamate, monomethyl succinate (FEMA GRAS 3810), monomenthyl glutamate (FEMA GRAS 4006), menthoxy-1,2-propanediol (FEMA GRAS 3784), menthoxy-2-methyl-1,2-propanediol (FEMA GRAS 3849), (1R,2S,5R)—N-(4-(cyanomethyl)phenyl)menthylcarboxamide (FEMA GRAS 4496), (1R,2S,5R)—N-(2-(pyridin-2-yl)ethyl)menthylcarboxamide (FEMA GRAS 4549), the menthane carboxylic acid esters and amides WS-3, WS-4, WS-5, WS-12, WS-14, WS-30 and mixtures thereof.

According to any one of the above embodiments, the citrus oil extract of the invention may be combined with may further comprise ingredient imparting a warming, a tingling, a salivating, a cleaning or an alcohol enhancement effect such as capsicum extract, spice extract (e.g. ginger, maniguette, all types of peppers including Sichuan, piperine, capsaicine, jambu extract, spilanthol.

It is understood that a person skilled in the art is perfectly able to design optimal formulations for the desired effect by admixing the above mentioned components of a flavoring or perfuming composition, simply by applying the standard knowledge of the art as well as by trial and error methodologies.

For the sake of clarity, it is also understood that any mixture resulting directly from a chemical synthesis, e.g. a reaction medium without an adequate purification, in which the compounds of the invention would be involved as a starting, intermediate or end-product could not be considered as a flavoring or perfuming composition according to the invention as far as said mixture does not provide the inventive compound in a suitable form for perfumery or for flavor. Thus, unpurified reaction mixtures are generally excluded from the present invention unless otherwise specified.

A further aspect of the invention provides a method for the preparation of an citrus oil extract of the invention comprising the following steps:
A) subjecting a citrus oil to hybrid thin film distillation to vaporize volatiles
B) the vaporized volatiles from A) enter into a cold condenser to convert the vapor into a liquid
C) the liquid from B) is collected as the citrus oil extract of the invention.

An embodiment of the invention is wherein the vapor extract from A) is passed through a fractionating column before step B). Preferably the fractionating column is integral to a hybrid thin film distillation apparatus.

An embodiment of the method of the invention is wherein the steps are repeated, preferably 2, 3, 4, 5 or more times, to further concentrate the citrus oil extract.

A working example of the method of the invention is provided in the accompanying examples.

Step A) of the method of the invention requires subjecting a citrus oil to hybrid thin film distillation to vaporize volatiles. As discussed above, the citrus oil can be from any citrus fruit from the family Rutacea, preferably but not limited to lemon, lime, orange, grapefruit, satsuma and tangerine, mandarin, yuzu, bergamot and pomelo. Citrus oils can be prepared using commonly known methods or obtained commercially from numerous suppliers of such materials.

A first step of the method of the invention requires subjecting a citrus oil to hybrid thin film distillation to vaporize volatiles. “Hybrid thin film distillation” is an extraction method which is known in the art and can be readily used by the skilled person. Essentially the method is a distillation method in which a citrus oil is heated for a short time under high vacuum conditions such that there is a reduced opportunity for intermolecular collisions and also at a temperature which reduces the opportunity for conversion of compounds to oxidative byproducts.

Apparatuses for performing hybrid thin film distillation are well known and readily available to the skilled person. An example of such an apparatus and a protocol for its use is provided in the accompanying examples.

In a preferred embodiment the hybrid thin film distillation is performed (i) using a vacuum of between 1.33 Pa and 13333 Pa, (ii) a temperature between 30-160° C., (iii) the citrus oil is exposed to the hybrid thin film distillation for between 3 to 15 mins; preferably less than 1 minute, more preferably between 3 and 15 seconds

In a preferred embodiment of the invention step A) is repeated twice or more, the second or final step A) having a higher temperature and lower pressure than the initial step A).

Preferably the vacuum of between 1.33 Pa and 13333 Pa, more preferably, 13.3 Pa to 1333 Pa, 66.6 Pa to 666 Pa, preferably 100 Pa to 400 Pa.

Preferably the temperature between 30° C. to 160° C., more preferably 50° C. to 130° C., 75° C. to 125° C., 80° C. to 120°, 90° C. to 110° C.

Preferably citrus oil is exposed to the hybrid thin film distillation for between 3 to 15 mins, 4 to 10 mins, 4 to 8 min, 5 to 6 mins. More preferably the citrus oil is exposed to the hybrid thin film distillation for between 3 to 15 seconds, 4 to 10 seconds, 4 to 8 seconds, 5 to 6 seconds.

Step B) of the method of the invention requires the vaporized volatiles from A) to be passed passed through a cold condenser to convert the vapor into a liquid

Cold condensers are standard laboratory apparatuses well known in the art and can be readily combined with fractionating columns apparatuses. They are linked in such a manner that the vapour extract from step B) passes directly into the cold condensers. An example of such an apparatus and a protocol for its use is provided in the accompanying examples.

Step C) of the method of the invention requires the liquid from B) is collected as the citrus oil extract of the invention. Again an example of such an apparatus and a protocol for its use is provided in the accompanying examples.

An optional step of the method of the invention is wherein the vapor extract from A) is passed through a fractionating column before step B). By using this optional step, it is possible to remove more of the terpenes and other oils from the extract and hence improve the solubility of the citrus oil extract of the invention

Fractionating columns are standard laboratory apparatuses well known in the art and can be readily combined with hybrid thin film distillation apparatuses. They are linked in such a manner that the vapour extract from step A) passes directly into the fractionating column. An example of such an apparatus and a protocol for its use is provided in the accompanying examples.

The invention will now be described in further detail by way of the following examples which illustrate the benefits and advantages of the present invention.

### EXAMPLES

### Example 1: Preparation of the of the Composition of the Citrus Oil Extract of the Invention

A method for preparing a citrus oil extract of the invention is provided below. The starting material was commercially available citrus oil.

Step 1

With the interior surface of a wiped-film evaporator with a fractionation column set to 80° C. to 120° C. and the pressure reduced to 2000 Pa to 3000 Pa, begin feeding citrus oil to the equipment. The feed rate should be sufficient to optimize the available evaporative capacity of the system and not overload the condenser. An initial reflux ratio is set and adjusted as necessary; so that the aldehyde concentration in the distillate is no greater than 0.5%. The feed-rate and/or pressure are adjusted to achieve a desirable distillate to residue ratio.

This step of the method of the invention removes the unwanted components present in the starting citrus oil.

Step 2

With the interior surface of a short-path distillation with an internal condenser set higher than in Step 1, for example to 100° C. to 120° C. and the pressure reduced to less than in Step 1, for example less than 150 Pa, begin feeding the residue from Step 1. The feed rate should be sufficient to optimize the available evaporative capacity of the system and not overload the condenser. The distillate and residue streams are collected separately as unique products, the ratio between which is determined by the composition of the feed.

### Example 2: Analysis of the Composition of the Citrus Oil Extract of the Invention

The present inventors chararcterised the oxidative byproduct compounds component of the citrus oil extract of the invention and compared this to the composition of citrus oil extracts prepared using traditional vacuum distillation methods. The results are provided below.

Samples were run using an Agilent 6890N GC system (Agilent Technologies, Santa Clara, CA) Inlet temperatures were set to 250° C. and the oven temperature program consisted of a linear gradient from 40° C. to 360° C. at 5° C./min. Injection volume 0.2 uL with a 100 to 1 split ratio.

Identification Analyses were performed with an Agilent 5975 quadrupole mass spectrometer equipped with Masshunter software (Agilent Technologies, Santa Clara, CA) and a ZB-5MSi capillary column of dimensions (Phenomenex, Torrence, CA) 30 mx0.25 mm. i.d.x0.25 μm). Helium was used as the carrier gas in the constant flow mode of 0.8 mL/min. The source was kept at 230° C., and the quadrupole was kept at 150° C. The transfer line and injector were maintained at 300° C. Electron impact ionization in the positive ion mode was used, scanning a mass range from 15-300 m/z from time 0 to time 2.4 minutes, and then scanning 33-450 m/z. Mass spectra matches were made by comparison of NIST 2008 version 2.0 standard spectra (NIST, Gaithersburg, Md.) as well as in house MS libraries. MS deconvolution was performed by AMDIS version 2.69 (NIST, Gaithersburg, Md.)

Quantitation Analyses were performed using the GC system's built in FID. Helium was used as the carrier gas in the constant flow mode of 1.4 mL/min. The FID temperature was set to 300° C., with the hydrogen fuel gas flow rate set to 40.0 mL/min and utility compressed air set to 400.0 mL/min. Makeup gas was turned off and lit offset was set at 1.

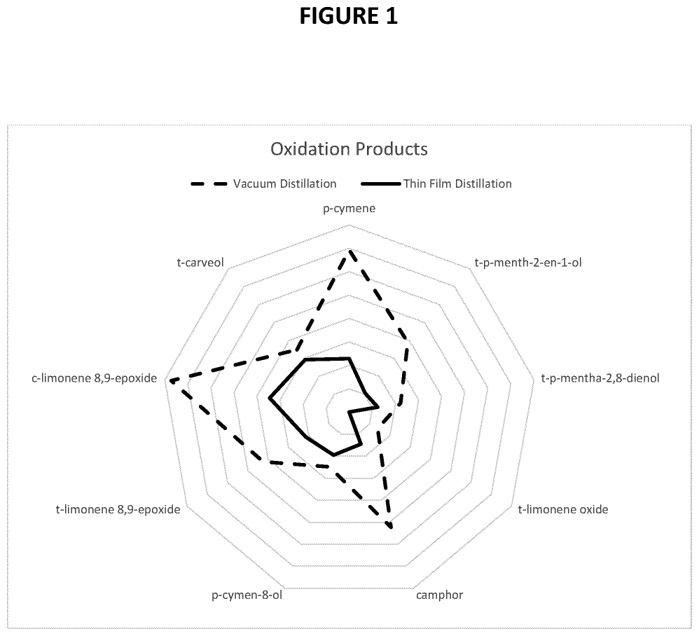

Using the above analysis method the composition of four samples was performed: traditional lemon oil extract using vacuum distillation, lemon oil extract of the invention, traditional lime oil extract using vacuum distillation, lime oil extract of the invention. The data is presented below and also for the lime extract in FIG. 1.

TABLE 1
GC analysis of oil extracts

| | | | Lemon | |
|---|---|---|---|---|
| | Lime Traditional | Lime Oil | Traditional | Lemon Oil |
| | Vacuum | extract of the | Vacuum | extract of the |
| | Distillation | invention | Distillation | invention |
| Component_{—} | ppm | ppm | ppm | ppm |
| p-cymene | 693 | 229 | 209 | 100 |
| t-p-menth-2-en-1-ol | 389 | 106 | 571 | 0 |
| t-p-mentha-2,8-dienol | 223 | 123 | 161 | 75 |
| t-limonene oxide | 140 | 0 | 168 | 0 |
| camphor | 523 | 145 | 1368 | 178 |
| p-cymen-8-ol | 248 | 195 | 296 | 116 |
| t-limonene 8,9- | 424 | 214 | 684 | 282 |
| epoxide | | | | |
| c-limonene 8,9- | 771 | 345 | 435 | 147 |
| epoxide | | | | |
| t-carveol | 347 | 292 | 1135 | 413 |

TABLE 2
GC data showing quantities of oxidation compounds in extracts
of the invention prepared from different citrus fruits

| | LIME | LEMON | ORANGE |
|---|---|---|---|
| | ppm | ppm | ppm |
| p-cymene | 229 | 100 | 0 |
| t-p-menth-2-en-1-ol | 106 | 149 | 0 |
| t-p-mentha-2,8-dienol | 123 | 0 | 1269 |
| t-limonene oxide | 0 | 0 | 2183 |
| camphor | 145 | 178 | 0 |
| p-cymen-8-ol | 0 | 116 | 388 |
| t-limonene 8,9-epoxide | 214 | 282 | 0 |
| c-limonene 8,9-epoxide | 345 | 147 | 990 |
| t-carveol | 292 | 413 | 7712 |
| | 1453 | 1385 | 12543 |

Here it can be clearly seen that the citrus oil extract of the invention has much less oxidative byproduct compounds than the extract prepared using traditional vacuum distillation methods. As stated above this is preferable to consumers since they impart undesirable notes to the extract.

### Example 3: Sensory Analysis Citrus Oil Extract of the Invention

Sensory analysis was done through descriptive analysis with a Hedonic scale of 0-5. Samples prepared in a standard taste solution (7% sucrose and 0.1% citric acid), presented blind to trained panelists and asked to rate the samples from 0-5 for freshness. The data is provided below in Table 3.

TABLE 3
Sensory analysis of the lime citrus oil extract of the invention

| | | Average |
|---|---|---|
| | Flavor | Freshness* |
| Traditional lime | Less body, flat & distilled | 3 |
| Vacuum | notes | |
| Distillation | | |
| Lime citrus oil | Bright, fresh, authentic | 4 |
| extract of the | | |
| invention | | |

*Freshness scale: 0-5, wherin 0 indicated no freshness, and 5 indicates high freshness.

1. A citrus oil extract comprising a reduced amount of oxidative byproduct compounds, wherein the amount of oxidative byproduct compounds is less than 2500 ppm

2. The citrus oil of claim 1 wherein the citrus fruit is selected from the group comprising: lemon, lime, grapefruit, satsuma and tangerine.

3. The citrus oil extract of claim 1 wherein the citrus fruit is lime and the amount of oxidative byproduct compounds is less than 1900 ppm.

4. The citrus oil extract of claim 1 wherein the citrus fruit is lemon and the amount of oxidative byproduct compounds is less than 1500 ppm.

5. The citrus oil extract of claim 1 wherein the oxidative byproduct compound is selected from the group consisting of: p-cymene, t-p-menth-2-en-1-ol, t-p-mentha-2,8-dienol, t-limonene oxide, camphor, p-cymen-8-ol, t-limonene 8,9-epoxide, c-limonene 8,9-epoxide and t-carveol.

6. The citrus oil extract claim 5 wherein the oxidative byproduct compound is: (i) p-cymene and the amount is 230 ppm or less, (ii) t-p-menth-2-en-1-ol and the amount is 110 ppm or less, (iii) t-p-mentha-2,8-dienol and the amount is 125 ppm or less, (iv) t-limonene oxide and the amount is 10 ppm or less, (v) camphor and the amount is 185 ppm or less, (vi) p-cymen-8-ol and the amount is 220 ppm or less, (vii) t-limonene 8,9-epoxide and the amount is 290 ppm or less, (viii) c-limonene 8,9-epoxide and the amount is 350 ppm or less, and/or (ix) t-carveol and the amount is 420 ppm or less.

7. The citrus oil extract of claim 1 wherein the citrus oil extract is lemon and the extract comprises (i) p-cymene and the amount is 100 ppm or less, (ii) t-p-menth-2-en-1-ol and the amount is 5 ppm or less, (iii) t-p-mentha-2,8-dienol and the amount is 75 ppm or less, (iv) t-limonene oxide and the amount is 5 ppm or less, (v) camphor and the amount is 180 ppm or less, (vi) p-cymen-8-ol and the amount is 120 ppm or less, (vii) t-limonene 8,9-epoxide and the amount is 290 ppm or less, (viii) c-limonene 8,9-epoxide and the amount is 150 ppm or less, and/or (ix) t-carveol and the amount is 420 ppm or less.

8. The citrus oil extract of claim 1 wherein the citrus oil extract is lime and the extract comprises (i) p-cymene and the amount is 230 ppm or less, (ii) t-p-menth-2-en-1-ol and the amount is 110 ppm or less, (iii) t-p-mentha-2,8-dienol and the amount is 125 ppm or less, (iv) t-limonene oxide and the amount is 5 ppm or less, (v) camphor and the amount is 150 ppm or less, (vi) p-cymen-8-ol and the amount is 200 ppm or less, (vii) t-limonene 8,9-epoxide and the amount is 220 ppm or less, (viii) c-limonene 8,9-epoxide and the amount is 350 ppm or less, and/or (ix) t-carveol and the amount is 300 ppm or less.

9. A flavoring or perfuming composition comprising the citrus oil extract according to claim 1.

10. A flavored consumer product comprising the citrus oil extract of claim 1 wherein the product is selected from the group consisting of: baked goods, dairy based products, dairy analogues, products based on fat and oil or emulsions thereof, milk products, confectionary products, desserts, chocolate and compound coatings, cereal products, non-alcoholic beverages, flavored carbonated and still mineral and table waters, alcoholic beverages or instant or ready-to-drink beverages.

11. A perfumed article comprising the citrus oil extract of claim 1 wherein the perfumed article is selected from the group consisting of: an aromatic water, a perfume, a cologne, a bath gel, a shower gel, a shampoo, a hair care product, a cosmetic preparation, a deodorant, an air freshener, a detergent, a fabric softener, and a household cleaner.

12. A method for the preparation of a citrus oil extract comprising the following steps:
A) subjecting a citrus oil to hybrid thin film distillation to vaporize volatiles;
B) moving the vaporized volatiles from A) into a cold condenser to convert the vapor into a liquid
C) collecting the liquid from B) as the citrus oil extract.

13. The method of claim 12 wherein the vapor extract from A) is passed through a fractionating column before step B).

14. The method of claim 12 wherein the hybrid thin film distillation is performed (i) using a vacuum of between 1.33 Pa and 13333 Pa, (ii) at a temperature between 30-160° C., (iii) by exposing the citrus oil to the hybrid thin film distillation for between 3 and 15 mins.

15. The citrus oil extract of claim 2 wherein the oxidative byproduct compound is selected from the group consisting of: p-cymene, t-p-menth-2-en-1-ol, t-p-mentha-2,8-dienol, t-limonene oxide, camphor, p-cymen-8-ol, t-limonene 8,9-epoxide, c-limonene 8,9-epoxide and t-carveol.

16. The citrus oil extract claim 15 wherein the oxidative byproduct compound is: (i) p-cymene and the amount is 230 ppm or less, (ii) t-p-menth-2-en-1-ol and the amount is 110 ppm or less, (iii) t-p-mentha-2,8-dienol and the amount is 125 ppm or less, (iv) t-limonene oxide and the amount is 10 ppm or less, (v) camphor and the amount is 185 ppm or less, (vi) p-cymen-8-ol and the amount is 220 ppm or less, (vii) t-limonene 8,9-epoxide and the amount is 290 ppm or less, (viii) c-limonene 8,9-epoxide and the amount is 350 ppm or less, and/or (ix) t-carveol and the amount is 420 ppm or less.

17. A flavoring or perfuming composition comprising the citrus oil extract according to claim 2.

18. A flavoring or perfuming composition comprising the citrus oil extract according to claim 7.

19. A flavoring or perfuming composition comprising the citrus oil extract according to claim 8.
